(19) United States
(12) Patent Application Publication
(10) Pub. No.: US 2012/0291266 A1
(43) Pub. Date: Nov. 22, 2012

(54) Carrier and Pressing Device Having the Same

(75) Inventors: Chian-Jung CHEN, Kaohsiung City (TW); Ching-Feng Hsieh, Taipei (TW)

(73) Assignee: Askey Computer Corporation, New Taipei City (TW)

(21) Appl. No.: 13/243,280

(22) Filed: Sep. 23, 2011

(30) Foreign Application Priority Data
May 19, 2011 (TW) 100117528

(51) Int. Cl. B23P 19/00; B23Q 1/25

(52) U.S. Cl. 29/700; 269/55

(57) ABSTRACT

A carrier and a pressing device for attaching a panel to a casing are disclosed. The carrier includes a carrier main body; a carrier plate; a plurality elastic components; and a supporting component. The carrier plate is configured to carry the panel. The supporting component is connected to the carrier main body and the carrier plate to be a pivot for the carrier plate to rotate around the carrier main body. Each of the elastic components is connected to the carrier plate and the carrier main body, such that the carrier plate may restore upon having force applied thereon and tilt, so as to be adapted to the different sizes of the panel and the casing. Therefore, the panel is completely attached to the casing, and the attachment of the panel and the casing is thus effectively improved.

### FIELD OF INVENTION

The present invention relates to a carrier and a pressing device having the carrier, and more particularly, to a carrier and a pressing device having the carrier for attaching a panel to a casing in an electronic product.

### BACKGROUND OF THE INVENTION

Panels are wildly used in commercial electronic products due to the easy operation. In the fabrication of these electronic products, the panel is pressed on the casing of the electronic product. In order to attach the panel to the casing of the electronic product, some pressing devices have been developed.

FIG. 1 shows the pressing device 1 for panels in the prior art. The pressing device 1 is used for pressing a panel to a casing of an electronic product. The pressing device 1 includes a base 11, a pressing mechanism 12, a carrier 13, a single track 14 disposed on the base 11 and a slidable seat 15 capable of sliding on the single track 14. A casing may be disposed on the carrier 13, and a panel may be carried on the slidable seat 15 so as to slide into the casing. The pressing mechanism 12 moves toward the carrier 13, and thus pushes and presses the carrier 13 to the casing, such that the panel is attached to the casing.

However, in the current technology, the actual thickness of the casing and the panel may be different from the design, such that the casing and the panel fail to completely attach with each other due to an existing gap between the casing and the panel. Therefore, some manufactures use adhesive pads to fill the gap between the casing and the panel. However, many manual operations are involved, such that the cost is increased and there are even inaccurate manual operations.

Accordingly, there is a need to provide a pressing device for overcoming the above drawbacks in the prior art.

### SUMMARY OF THE INVENTION

It is an aspect of the present invention to provide a pressing device for attaching a panel to a casing.

The present invention further provides a carrier for carrying a panel. The carrier includes a carrier main body; a carrier plate disposed on the carrier body and having a surface for carrying the panel; a plurality elastic components disposed around the carrier plate, wherein each of the elastic components has two ends respectively connected to the carrier plate and the carrier main body, thereby the carrier plate moving corresponding in position to the carrier main body; and a supporting component having two ends respectively connected between the carrier body and the carrier plate, wherein the supporting component is a pivot for the carrier plate to rotate around the carrier main body.

In one embodiment, the supporting component is a sphere, and the carrier main body has a portion having an interior concave surface for contacting and positioning the supporting component. The carrier may further include a limiting component having two ends connected to the carrier plate and the carrier main body, thereby limiting rotation of the carrier plate, wherein the limiting component is an elastic multistage cylinder.

The present invention further includes a pressing device for attaching a panel to a casing, wherein the casing has a window and an opening. The pressing device includes a main body having a plurality of tracks, wherein the tracks are separated with and parallel to one another; a mounting base disposed in the main body for mounting and positioning the casing; the above carrier for carrying the panel, wherein the tracks are disposed through the carrier, and the carrier moves along the tracks and toward the carrier, thereby carrying the panel into the casing to be corresponding in position to the window; a pressing mechanism disposed in the main body and having a protruding portion corresponding to an outline of the casing, wherein the pressing mechanism is allowed to move toward the carrier, so as to press the casing mounted on the mounting base, such that the casing moves toward the carrier, the panel is pressed and attached into the casing, and the window is thus closed; and a plurality of guiding poles passing through the pressing mechanism for guiding the pressing mechanism to move in a predetermined direction.

In one embodiment, the main body may have a plurality of linear elastic components such as springs for the mounting based to be flexibly raised and lowered corresponding to the main body. The mounting base has a slot for positioning the casing. The mounting base has a through hole, and the main body has a supporting component passing through the through hole of the mounting base for supporting the carrier. The pressing device further includes first driving device, a second driving device and a third driving device, wherein the first driving device is connected to the pressing mechanism, so as to drive the pressing mechanism to move toward the mounting base; the second device is connected to the carrier, so as to drive the carrier to move toward the mounting base; and the third driving device is connected to the supporting component, so as to drive the supporting component to protrude from the through hole of the mounting base for supporting the carrier.

In addition, the first, second and third driving devices are pressure cylinders or oil pressure cylinders. The guiding poles may be disposed around the pressing mechanism. The pressing mechanism and the mounting base have a Teflon pressing portion.

Hence, the present invention provides a carrier and a pressing device for attaching a panel to a casing. The carrier includes a carrier main body; a carrier plate; a plurality elastic components; and a supporting component. The carrier plate is configured to carry the panel. The supporting component is connected to the carrier main body and the carrier plate to be a pivot for the carrier plate to rotate around the carrier main body. Thus, the carrier plate may restore upon having force applied thereon and tilt, so as to be adapted to the different sizes of the panel and the casing. Therefore, the panel is completely attached to the casing, such that the attachment of the panel and the casing is effectively improved.

### BRIEF DESCRIPTION OF THE DRAWINGS

FIG. 1 is a schematic view showing a pressing device for a panel in the prior art;

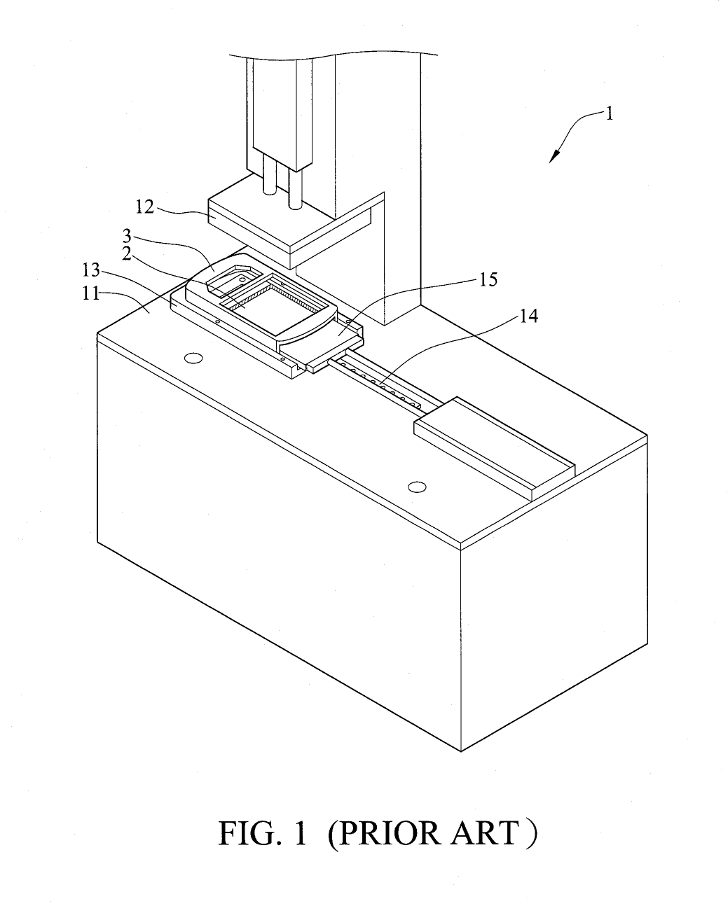

FIG. 2 is a top view of a carrier according to the embodiment of the present invention;

FIG. 3 is an enlarged view along the A-A line of the carrier in FIG. 2;

FIG. 4 and FIG. 5 are schematic views showing the pressing device having the carrier of FIG. 2; and

FIG. 6 is a flow chart showing the steps of using the pressing device of the present invention for attaching a panel to a casing.

### DETAILED DESCRIPTION OF THE PREFERRED EMBODIMENTS

The following embodiments are used for illustrating the present invention. A person skilled in the art can easily conceive the other advantages and effects of the present invention.

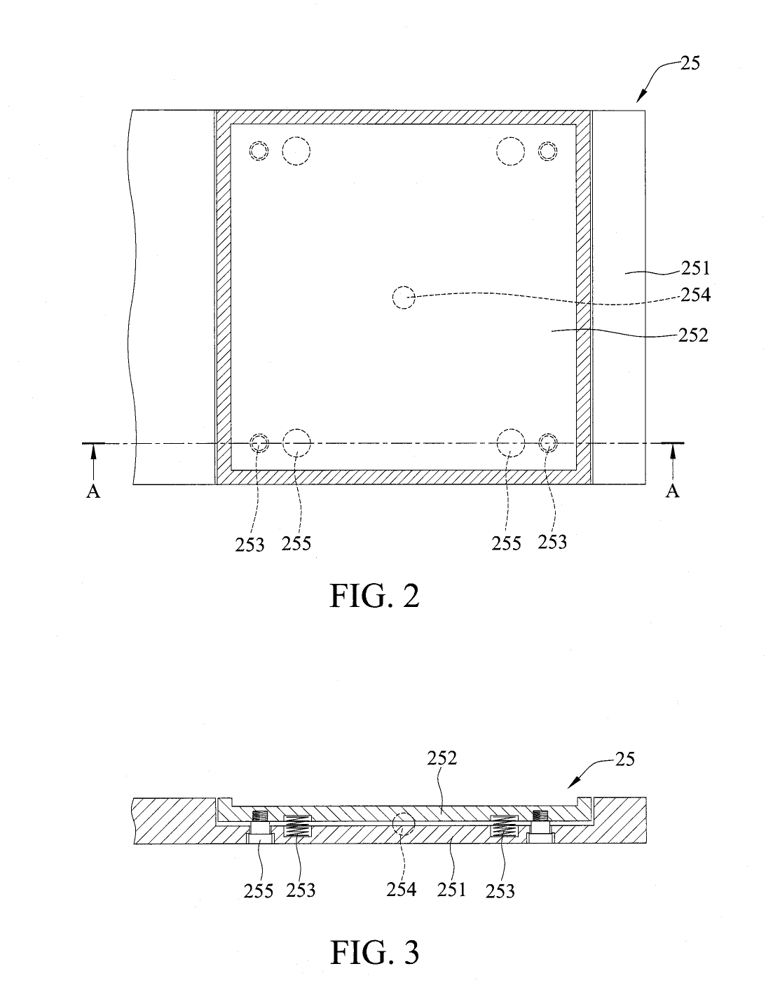

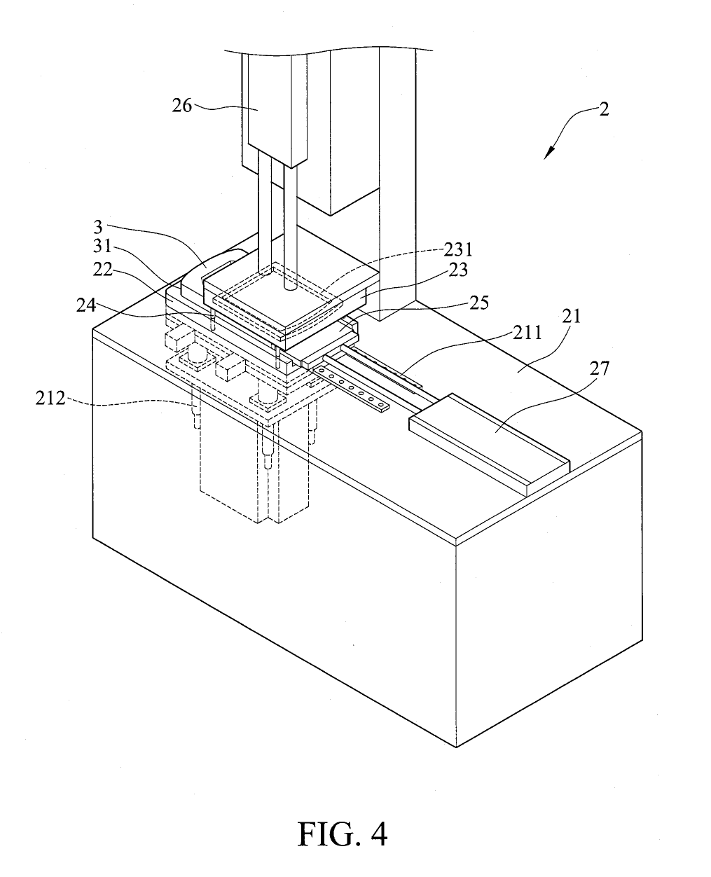

FIG. 2 is a top view of a carrier, and FIG. 3 is an enlarged view along the A-A line of the carrier in FIG. 2. The carrier 25 is used for carrying a panel. The carrier 25 includes a carrier main body 251, a carrier plate 252, four elastic components 253 and a supporting component 254. The carrier plate 252 is disposed in the carrier main body 251, and has a surface for carrying the panel 4. Each of the elastic components 253 has two ends respectively connected to the carrier plate 252 and the carrier main body 251. The elastic components 253 are arranged around the carrier plate 252, such that the carrier plate 252 may recover upon the tilt resulting from the force applied thereon. The elastic components 253 may be springs. The amount and type of the elastic components 253 may be optionally changed.

The supporting component 254 has two ends respectively connected between the carrier main body 251 and the carrier plate 252 for being a pivot at which the carrier plate 252 rotates around the carrier main body 251. Therefore, while having force applied thereon, the carrier plate 252 may take the supporting component 254 as a pivot and tilt to the carrier main body 251. In addition, when the carrier plate 252 is forced to tilt, the carrier plate 252 may recover due to the elastic components 253. Hence, the carrier plate 252 may adapt to variations of thicknesses and sizes of panels.

the supporting component 254 is a sphere to be a pivot at which the carrier plate 252 rotates around the carrier main body 251. The carrier main body 251 has a portion with an interior concave surface for contacting and positioning the supporting component 254. Certainly, the supporting component 254 may have other shapes such as a cone shape. The carrier 25 further includes a limiting component 255 such as an elastic multistage cylinder. The limiting component 255 has two ends respectively connected to the carrier plate 252 and the carrier main body 251 for limiting the rotation of the carrier plate 252 around the carrier main body 251, so as to prevent the elastic components from flexible deformation due to the rotation of the carrier plate 252.

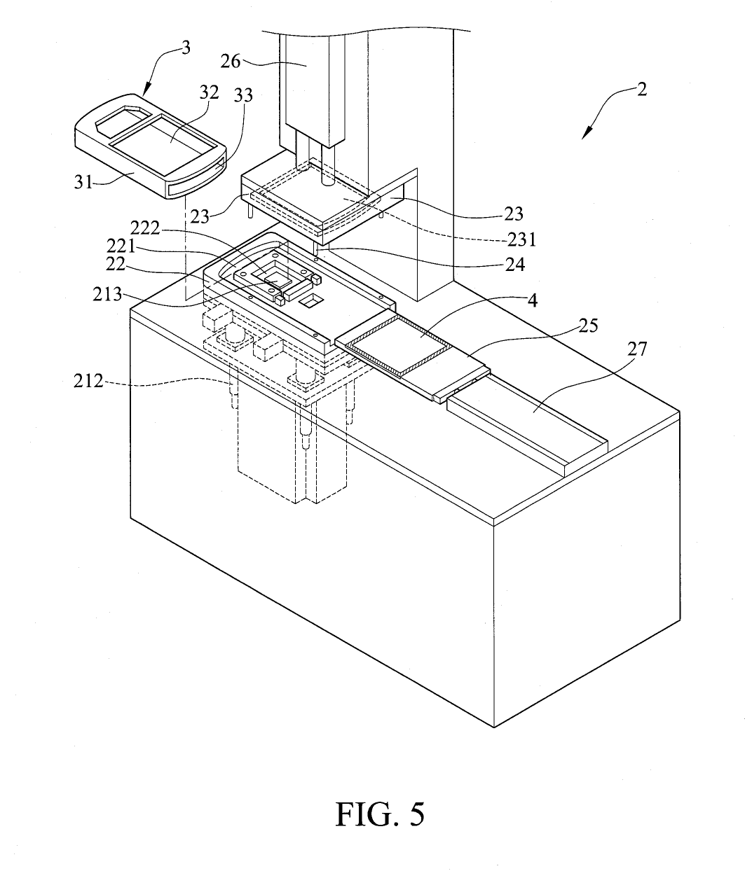

FIG. 4 and FIG. 5 show that the pressing device having the above carrier is used for attaching a panel to a casing. As shown in figures, the pressing device 2 is used for attaching a panel 4 to a casing 3, wherein the casing 3 has a window 32 and an opening 3 and has a first positioning portion 31 on the periphery of the casing 3. The first positioning portion 31 may be a positioning plate. The pressing device 2 includes a main body 21, a mounting base 22, a pressing mechanism 23, a plurality of guiding poles 24 and a carrier 25. The mounting base 22 is disposed on the main body 21, and is movable upward and downward. The main body 21 includes a supporting component 213 for supporting the carrier 25 so as to prevent the carrier 25 from deformation and ensure the attachment of the panel 4 to the casing 3.

The main body 21 has four linear elastic components 212 and two tracks 211, wherein the tracks 21 are separated from and parallel to each other. Each linear elastic component 212 is disposed between the mounting base 22 and the main body 21, and has two ends respectively connected to the mounting base 22 and the main body 21, such that the mounting base 22 is allowed to raise or lower corresponding to the main body 21. Each of the linear elastic components 212 may be a spring. The two tracks 211 may allow the carrier 25 with a large area to move thereon, and thus the carrier 25 may provide sufficient area for carrying the panel 4 with a large area. The amount of these linear elastic components 212 and the tracks 211 may be optionally changed. Further, while the casing 3 is elastic, the linear elastic components 212 may be omitted.

The casing 3 may be mounted on the mounting base 22, and the mounting base 22 has a second positioning portion 221 corresponding to the first positioning portion 31 for positioning the casing 3. As shown in figures, the second positioning portion 221 of the mounting base 22 may be a slot. The mounting base 22 has a through hole 222, and the supporting component 213 protrudes from the through hole 222, such that the carrier 25 is supported by the supporting component 213. Certainly, the shape of the second positioning portion 221 may be changed in response to the first positioning portion 31, so as to effectively position the casing 3.

The pressing mechanism 23 is disposed in the main body 21, and has a protruding portion 231 corresponding to the outline of the casing. The protruding portion 231 moves with the pressing mechanism 23 toward the mounting base 22, so as to press the casing 3 mounted on the mounting base 22. While the pressing mechanism 23 presses the casing 3, the casing 3 moves toward the carrier 25, such that the panel 4 is pressed and attached in the casing so as to seal the window 32. In addition, the pressing mechanism 23 pressing the periphery of the casing via the protruding portion 231, so as to prevent the casing 3 from having uneven force applied thereon, such that the casing 3 would not sway on the mounting base 22, and the protruding portion 231 effectively improve the attachment of the panel 4 to the casing 3. Hence, the yield of the electronic product having the casing 3 and the panel 4 is increased. Further, the pressing mechanism 23 and the mounting base 22 have a Teflon (polytetrafluoroethylene) pressing portion to extend the life of the pressing mechanism 23 and the mounting base 22 due to the Teflon having wear-resistance.

The guiding poles 24 pass through the pressing mechanism 23 for guiding the pressing mechanism 23 to move in a vertical direction corresponding to the mounting base 22, and the pressing mechanism 23 would not shift in a horizontal direction corresponding to the mounting base 22 upon movement, such that even the pressing device is used for many times, the pressing mechanism 23 still effectively presses and moves the casing 3 mounted on the mounting base 22.

The carrier 25 is disposed on the tracks 211 for carrying the panel 4, and the carrier 25 moves along the tracks 211 and toward the mounting base 22, such that the panel 4 is moved from the opening 33 to the corresponding window 32 in the casing 3 as shown in FIG. 4. While the casing 3 is pressed by the pressing mechanism 23, the casing 3 moves toward the carrier 25 for attaching with the panel 4 on the carrier 25, which is moved into the casing 3, and each linear elastic component 212 is deformed due to the above press and movement. Thus, the mounting base 22 is pressed and moved by the pressing mechanism 23.

It is noted that the carrier plate 252 may recover via the elastic components 253 upon having force applied thereon, such that the carrier plate 252 may be adapted to various sizes of the casing 3 and panel 4, and the panel 4 may be completely attached to the casing 3. Hence, the pressing device 2 may improve the attachment of the panel 4 to the casing 3, and thus improve the yield of the electronic product.

In the present embodiment, the pressing device 2 may further include a third driving device (not shown) connected to the supporting component 213 for driving the supporting component 213 to protrude from the through hole 222 of the mounting base 22 and supporting the carrier 25, so as to prevent the carrier 25 from deformation. As shown in FIG. 4, the pressing device 2 further includes a first driving device 26 connected to the pressing mechanism 23 for driving the pressing mechanism 23 to move toward the mounting base 22. In addition, the pressing device 2 further includes a second driving device 27 connected to the carrier 25 for driving the carrier to move toward the mounting base 22, so as to move the panel 4 into the casing 3. The first driving device 26 and the second driving device 27 may be, but not limited to, pressure cylinders or oil pressure cylinders.

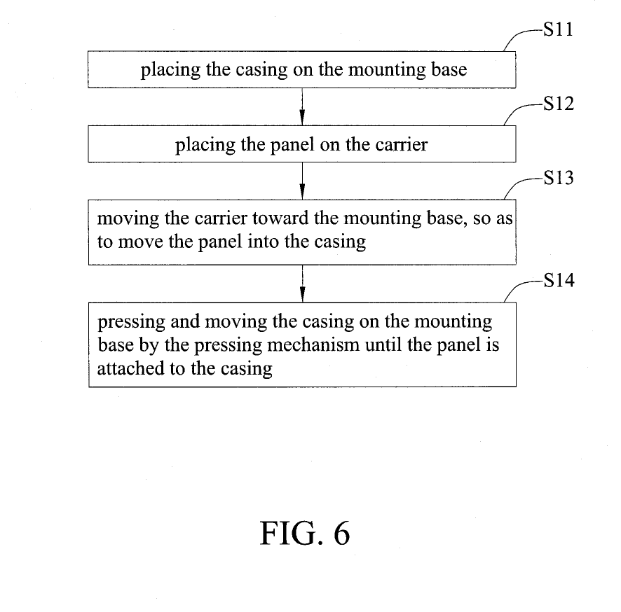

FIG. 6 is a flow chart showing that the pressing device 2 is used for attaching a panel to a casing. As shown in FIG. 6, in the step S11, the casing 3 is placed on the mounting base 22. In the step S12, the panel 4 is placed on the carrier 25. In the step S13, the carrier 25 moves along the tracks 211 and toward the mounting base 22, so as to move the panel 4 from the opening 33 into the corresponding window 32 of the casing 3, such that the supporting component 213 protrudes from the through hole 222 of the mounting base 22 for supporting the carrier 25, and the carrier 25 is prevented from deformation while having force applied thereon. In the step S14, the casing 3 on the mounting base 22 is pressed and moved by the pressing mechanism 23 of the pressing device 2, such that the casing moves toward the carrier 25 until the casing is attached with the panel 4, which is moved into the casing 3, such that the panel 4 is attached to the casing 3, and the window 32 is sealed to complete the attachment of the panel 4 to the casing 3.

Accordingly, the present invention provides a carrier and a pressing device for attaching a panel to a casing. The carrier includes a carrier main body; a carrier plate; a plurality elastic components; and a supporting component. The carrier plate is configured to carry the panel. The supporting component is connected to the carrier main body and the carrier plate to be a pivot for the carrier plate to rotate around the carrier main body. Each of the elastic components is connected to the carrier plate and the carrier main body, such that the carrier plate may restore upon having force applied thereon and tilt, so as to be adapted to the different sizes of the panel and the casing. Therefore, the panel is completely attached to the casing, and the attachment of the panel and the casing is thus effectively improved.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. A carrier for carrying a panel, comprising:
a carrier main body;
a carrier plate disposed on the carrier body and having a surface for carrying the panel;
a plurality elastic components disposed around the carrier plate, wherein each of the elastic components has two ends respectively connected to the carrier plate and the carrier main body, thereby the carrier plate moving corresponding in position to the carrier main body; and
a supporting component having two ends respectively connected to an intermediate portion between the carrier body and the carrier plate, wherein the supporting component is a pivot for the carrier plate to rotate around the carrier main body.

2. The carrier of claim 1, wherein the supporting component is a sphere, and the carrier main body has a portion having an interior concave surface for contacting and positioning the supporting component.

3. The carrier of claim 1, further comprising a limiting component having two ends connected to the carrier plate and the carrier main body, thereby limiting rotation of the carrier plate, wherein the limiting component is an elastic multistage cylinder.

4. A pressing device for attaching a panel to a casing, wherein the casing has a window and an opening, comprising:
a main body having a plurality of tracks, wherein the tracks are separated with and parallel to one another;
a mounting base disposed in the main body for mounting and positioning the casing;
the carrier of claim 1 for carrying the panel, wherein the tracks are disposed through the carrier, and the carrier moves along the tracks and toward the carrier, thereby carrying the panel into the casing to be corresponding in position to the window;
a pressing mechanism disposed in the main body and having a protruding portion corresponding to an outline of the casing, wherein the pressing mechanism is allowed to move toward the carrier, so as to press the casing mounted on the mounting base, such that the casing moves toward the carrier, the panel is pressed and attached into the casing, and the window is thus closed; and
a plurality of guiding poles passing through the pressing mechanism for guiding the pressing mechanism to move in a predetermined direction.

5. The pressing device of claim 4, further comprising a plurality of linear elastic components connected to the mounting base, thereby the mounting base being raised or lowered corresponding to the main body, wherein the mounting base has a slot for positioning the casing.

6. The pressing device of claim 5, wherein the linear elastic components are springs, the mounting base has a through hole, and the main body has a supporting component passing through the through hole of the mounting base for supporting the carrier.

7. The pressing device of claim 6, further comprising a first driving device, a second driving device and a third driving device, wherein the first driving device is connected to the pressing mechanism, so as to drive the pressing mechanism to move toward the mounting base; the second device is connected to the carrier, so as to drive the carrier to move toward the mounting base; and the third driving device is connected to the supporting component, so as to drive the supporting component to protrude from the through hole of the mounting base for supporting the carrier.

8. The pressing device of claim 7, wherein the first, second and third driving devices are pressure cylinders or oil pressure cylinders.

9. The pressing device of claim 4, wherein the guiding poles are disposed around the pressing mechanism.

10. The pressing device of claim 4, wherein the pressing mechanism and the mounting base have a pressing portion made of polytetrafluoroethylene.
